(19) United States
(12) Patent Application Publication
(10) Pub. No.: US 2007/0094038 A1
(43) Pub. Date: Apr. 26, 2007

(54) Franchising business method

(75) Inventors: John Kling, Irvine, CA (US); James Cover, Irvine, CA (US); Suzi Munoz, Irvine, CA (US)

Correspondence Address: LOZA & LOZA LLP, 6285 EAST SPRING STREET, # 327-N, LONG BEACH, CA, 90808, US

(73) Assignee: YOR Holdings Management Corporation

(21) Appl. No.: 11/240,842

(22) Filed: Sep. 30, 2005

(51) Int. Cl. G06Q 99/00

(52) U.S. Cl. 705/1

(57) ABSTRACT

At least one embodiment of the invention pertains to a business method for efficiently allocating and operating franchises based on customer assignment rather than the traditional geographical assignment. A franchisor allocates customers to a particular franchise based on the franchisee's ability to service such customers. A franchisor can control the growth of a franchisee by (1) assigning specific prospects to the franchisee, (2) tracking the franchisee's initial surveys of the assigned prospects, (3) assign the surveyed prospects to the franchisee as customers, and (4) only assigning additional customers to the franchisee upon satisfactory servicing of its currently assigned customers. The franchisor also provides centralized sales, marketing, distribution, and accounting support to the franchisees.

### FIELD

Various embodiments of the invention pertain to a method for efficiently assigning and operating franchises. One implementation provides for assigning franchises based on allocated prospects.

### BACKGROUND

The natural consequence of successful business ventures is that they tend to expand or grow. However, an expanding business often faces logistical difficulties as a centrally managed company must serve an ever-increasing number of customers and train more and more employees. Moreover, such expansion may also cause a decrease in quality of the products or services provided. This is particularly true in service businesses where customer interaction and satisfaction tend to be very important in the continued success of the business.

Another aspect of managing a growing business is being able to properly motivate employees to work to make the business succeed. One way in which such expansion and motivation has been accomplished is through a franchisor-franchisee business model. In the traditional franchisor-franchisee business model, a franchisor grants one or more franchisees certain rights to represent the business within a given geographical location. As illustrated in FIG. 1, the franchisor typically divides each franchise into geographical regions 102, 104, 106, and 108. Each franchisee is sold or assigned a region in exchange for sharing profits with the franchisor or some other financial arrangement. Such franchise regions are typically non-overlapping so that no two franchises can service the same customer(s).

When applied to a business where services are provided to customers, this geographical assignment of franchise regions 102, 104, 106, and 108 typically means that only the franchisee within that region can provide the service to customers or potential customers/prospects within his/her assigned region. Other franchisees may be prohibited from providing the services to customers or potential customers within another franchisee's assigned region. The problem with such geographical assignment is that a franchisee may not be able to service many customers within his/her assigned region. That is, many customers or prospects within a region may not be serviced because of a short-handed or underperforming franchisee. Yet other franchisees cannot enter such region because of the franchising arrangement.

Additionally, under the traditional franchise business models, the franchisee is typically on his/her own when acquiring customers or expanding his/her customer base within the assigned geographical region. While the franchisee may be technically capable of providing a service, he/she may have more challenges developing customers, generating sales or acquiring business training to run the franchise. In fact, the failure to acquire clients/customers often leads to the failure of the franchise. For example, the fire services industry (e.g., fire extinguisher recharging, maintenance, inspection, and/or repair services) tends to be highly fragmented with many small operators having service personnel performing the services as well as sales and soliciting of new customers. Because service personnel are usually not trained to conduct sales or solicit customers, performing both the service and sales role may contribute or lead to the failure of such franchise.

In traditional franchises, once the franchisor has assigned or granted a franchisee a region, little oversight may occur regarding how well the franchisee services the customers within his/her assigned region. An underperforming franchisee may provide substandard services to customers within his/her region. Ultimately, such substandard services reflect poorly on all other associated franchises, not just the underperforming franchisee.

Moreover, with non-exclusive geographically defined franchises, two or more franchises may end up competing against each other for the same customer. This would tend to down profit margins.

Additionally, in many service industries potential customers are approached without prior knowledge of their specific needs. Thus, selling to these potential customers is less effective.

### SUMMARY OF THE INVENTION

One embodiment of the invention pertains to a method for assigning and/or operating franchises, comprising: (a) identifying one or more potential customers or prospects, (b) assigning a potential customer to a franchise, (c) monitoring the work performed by the franchise for the assigned potential customer, and (d) assigning additional potential customers to the franchise only if the potential customer has been adequately serviced. The franchise is defined by the customers assigned to the franchisee, not a geographical region. The franchisee performs a survey of the potential customer's facility prior to contacting the assigned potential customers. A potential customer becomes permanently assigned to the franchisee once the franchisee has surveyed or performed work for the potential customer. In one example, a plurality of potential customers are initially allocated to the franchisee, and the assigned potential customers are selected from the allocated potential customers. The franchisor may balance the assignment of the potential customers to the franchisee based on the size and nature of the potential customers' real estate properties.

The potential customer becomes a permanent customer of the franchisee upon the franchisee surveying the potential customer. This survey information is then used by the franchisor to sell services or products to the potential customer on behalf of the franchisee. The franchisor then generates a work order for the franchisee based on the services or products sold to the potential customer. The franchisee then delivers the sold services or products to the potential customer. The franchisor generates invoices for the services or products sold to the potential customer on behalf of the franchisee. The franchisor pays the franchisee its portion of the payments received from the potential customer.

One feature of the invention provides a franchising method where franchises are defined by the customers assigned to each franchise and not geographical boundaries or regions. Thus, multiple franchises may operate in the same geographical region. This method of allocating franchises allows a franchisor to more efficiently allocate customers to those franchises that are able to serve them. Additionally, the franchisor may provide centralized sales, marketing, distribution, and accounting support to the franchises. That is, the franchisor develops potential customers for the franchisees, sells services and/or products to the customers on behalf of the franchisees, maintains invoicing and billing on behalf of the franchisees, and provides work orders and/or products to the franchisees. The franchisor may also provide business and technical training to a franchisee to assist him/her in operating a franchise.

According to one embodiment of the invention, the franchising operations provide fire extinguisher maintenance, inspection, repair, and/or recharging services and/or sale of fire safety products. In this fire extinguisher services and/or products operation the franchisee uses a mobile device to collect customer survey information, communicate customer information to the franchisor in near real-time, and/or receive work orders from the franchisor.

### BRIEF DESCRIPTION OF THE DRAWINGS

FIG. 1 illustrates a conventional geographically-assigned franchise business model.

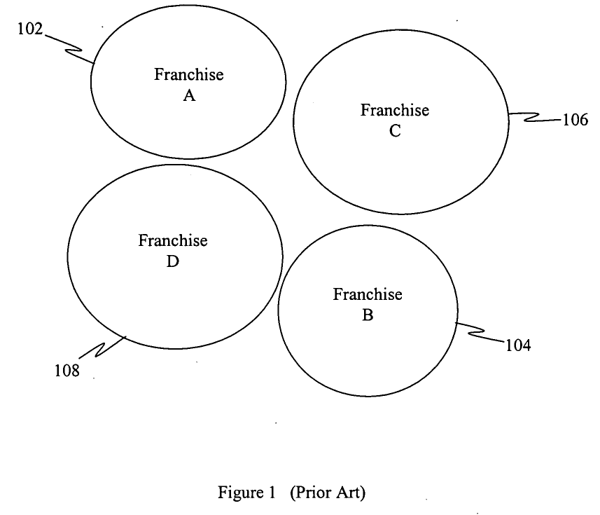

FIG. 2 illustrates a customer-centric franchise business model according to one embodiment of the invention.

FIG. 3 illustrates a method of assigning customers or potential customers in a customer-centric franchise business model according to one embodiment of the invention.

FIG. 4 illustrates a method of operating a franchise in a customer-centric franchise business model according to one embodiment of the invention.

FIG. 5 illustrates a system for operating a customer-centric business model according to one embodiment of the invention.

### DETAILED DESCRIPTION

In the following description numerous specific details are set forth in order to provide a thorough understanding of the invention. However, one skilled in the art would recognize that the invention might be practiced without these specific details. In other instances, well known methods, procedures, and/or components have not been described in detail so as not to unnecessarily obscure aspects of the invention.

In the following description, certain terminology is used to describe certain features of one or more embodiments of the invention. For instance, the term “franchisor” refers to any party or entity that assigns, sells, and/or licenses others to use a business name, image, product(s), and/or service(s) within a particular line of business. A “franchisee” refers to any party or entity that agrees to operate a business, sell products, and/or provide a service under a particular business name or image. The term “franchise” refers to an operation assigned to a franchisee. The term “customer” and “client” are interchangeably used to broadly refer to entities (e.g., people, properties, etc.) with whom a relationship has been established. The terms “potential customer” and “prospect” are interchangeably used to refer to entities with whom no contractual relationship has been established.

One feature of the invention provides a way to efficiently form a franchise based on customer assignment rather than the traditional geographical assignment. A franchisor allocates customers to a particular franchise based on the franchisee's ability to service such customers. A franchisor can control the growth of a franchisee by (1) assigning specific customers to the franchisee, (2) tracking the franchisee's services to the assigned customers, and (3) only assigning additionally customers to the franchisee upon satisfactory servicing of its currently assigned customers.

Another feature of the invention provides an efficient system that allows a franchisor to track and/or monitor multiple franchisees and their ability to timely service existing clients or customers. Thus, the franchisor can efficiently maintain the quality and image of the overall franchise operation.

Yet another feature of the invention enables a franchisee to focus on providing the franchised service by centralizing customer development (e.g., marketing, sales, etc.) with the franchisor. This permits the sales, marketing, and/or distribution to be ran by the franchisor, thereby freeing the franchisee of such tasks.

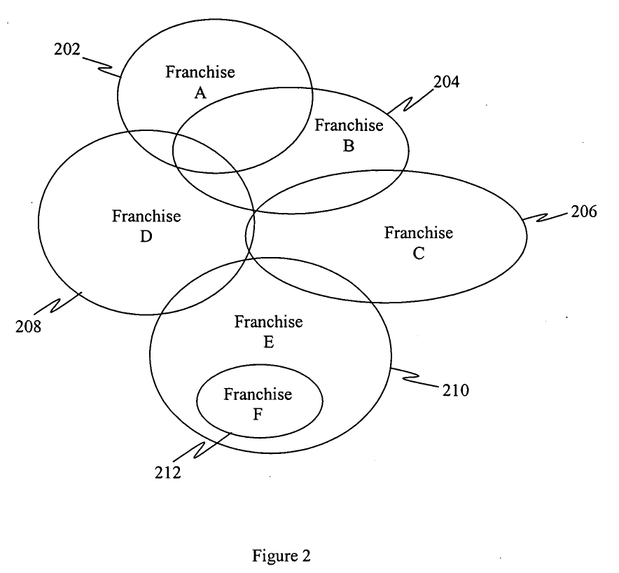

FIG. 2 illustrates a customer-centric franchise business model according to one embodiment of the invention. In this customer-centric franchise business model, the central business operator (e.g., franchisor) allocates, sells, and/or licenses a business operation (e.g., a franchise) to a franchisee by assigning particular customers or potential customers to that franchisee. In contrast to traditional franchising models where franchises are allocated based on geographical exclusivity, the franchising business model of the present invention can allocate multiple franchises 202, 204, 206, 208, 210, and 212 in overlapping geographical regions. This is because at the core of the present franchising business model is the idea that the customers or clients makeup a franchise, not geographical boundaries or a location.

According to the customer-centric business franchising system of the present invention, franchises are defined by their assigned or allocated customers and may be geographically separate (e.g., Franchise A is geographically separated from Franchise E), geographically overlapping (e.g., Franchise A geographically overlaps with Franchises B and D), and/or geographical co-extensive (e.g., Franchise F falls within the geographical region of Franchise E).

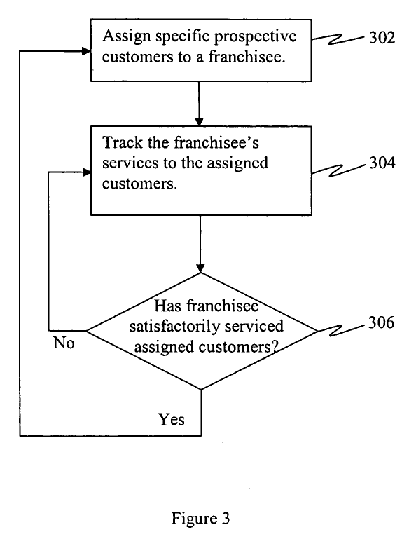

FIG. 3 illustrates a method of assigning customers or potential customers in a customer-centric franchise business model according to one embodiment of the invention. Initially, a franchisee is assigned one or more potential customers by the franchisor 302. These may be potential customers that the franchisor has contacted about their need for the franchised services and/or products. The franchisor then tracks the performance of said franchisee with the assigned customers or potential customers 304. This may encompass tracking sales, services, determining customer satisfaction with services provided, reporting by the franchisee, etc. If the franchisee has timely or satisfactorily provided services and/or products to the assigned customer(s) 306, then additional customers or potential customers may be assigned 302. Otherwise, the franchisor continues to monitor the franchisee's performance 304 without assigning additional potential customers.

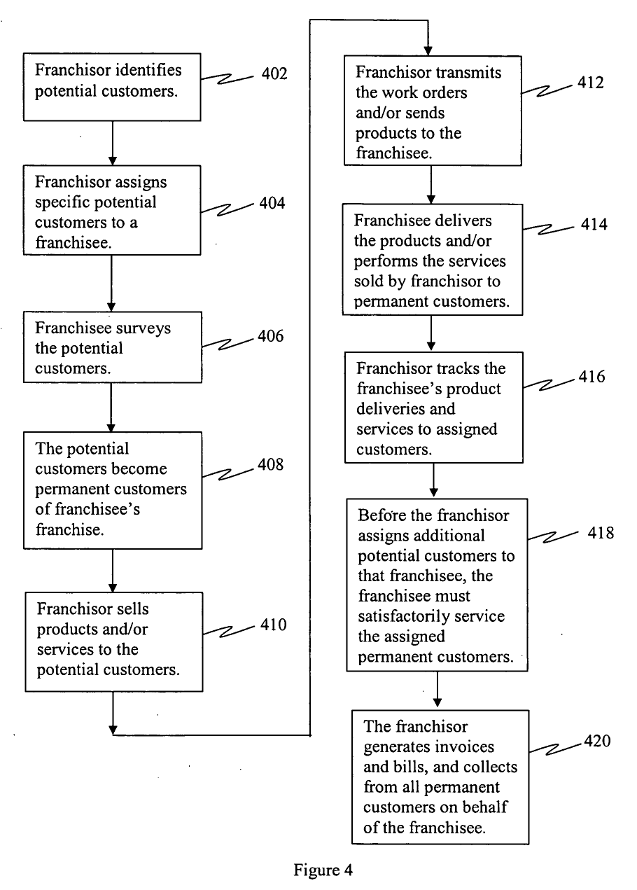

FIG. 4 illustrates a method of operating a franchise in a customer-centric franchise business model according to one embodiment of the invention. The franchisor identifies prospective or potential customers 402. This may be accomplished by the franchisor's centrally managed team that identifies potential customers based on one or more criteria. For instance, where properties (e.g., apartments, residences, commercial business, etc.) are of interest, the franchisor may identify one or more of these types of properties within a geographical region. The franchisor then assigns specific potential customers to a franchisee 404. This may be a new franchisee to whom the franchisor assigns one or more potential customers. The franchisor may allocate a number of identified potential customers (e.g., properties) to a franchisee but assign only a few at a time. The franchisee performs an initial survey or visit with the potential customers to assess their needs 406. Upon completing the initial survey or visit, the assigned potential customers become permanent customers of franchisee's franchise 408.

According to one embodiment of the invention, the franchisor retains ownership of potential customer and permanent customer database and maintains and processes the data collected by franchisee surveys. The franchisor may sell products and/or services to the potential customers 410, thereby making them permanent customers of the assigned franchisee. The franchisor transmits the work orders and/or sends products to the franchisee 412. The franchisee delivers the products and/or performs the services sold by franchisor to permanent customers 414. The franchisor tracks the franchisee's product deliveries and/or services to assigned customers 416 via progress reports or other feedback. Before the franchisor assigns additional potential customers to that franchisee, the franchisee must satisfactorily provide services and/or products to the assigned permanent customers 418. The franchisor generates invoices and bills, and collects from all permanent customers on behalf of the franchisee 420.

According to one embodiment of the invention, the franchisee's franchise or “franchise territory” is defined by its assigned potential and permanent customers and not a geographical area or specified location. The franchisee cannot obtain potential or permanent customers not assigned by the franchisor. Thus, the franchisor is able to provide central sales, marketing, accounting, and other support while the franchisee can focus in providing the service or product.

To facilitate growth of franchises, one feature of the invention allocates a certain number of potential customers or sites upon initiating a franchise. For example, in a fire services franchise operation, the franchisor may allocate a certain number of properties (e.g., apartment buildings, commercial buildings, residences, hotels, etc.). The number of allocated properties may provide the franchisee a sufficient/reasonable number of customers to operate his/her franchise. An allocation of properties does not mean that those properties are assigned customers. Instead, the franchisor uses the allocated properties to periodically (or as needed) assign potential customers to the franchisee. As the franchisee completes surveys of the assigned properties, other allocated properties are assigned to the franchisee for surveying.

Surveyed properties become part of the franchisee's permanent customers and are not assigned to any other franchisee. This is the case even if the property owner of an assigned property does not engage or hire the franchisee. Properties may remain assigned to the franchisee who surveyed them so long as (1) services or products are rendered to that property or customer or (2) the franchisee performs periodic updating surveys of the properties.

If a franchisee desires additional allocations, for future growth for instance, then he/she may buy them from the franchisor, at the discretion of the franchisor. This would facilitate a franchisee's expansion in a particular region without the risk of other franchisees acquiring potential customers in the same region. However, it should be clear that the allocations may be based on other criteria (e.g., such as property type, number of units, etc.) than geographical location.

The surveys performed by the franchisee have the goal of obtaining as much information as possible about a property or potential customer prior to contacting them. The franchisor uses this information to better target and assesses the needs of a particular property or potential customer when contacting them. Based on this survey the franchisor is also able to determine the approximate cost of services/products that a property or potential customer will need.

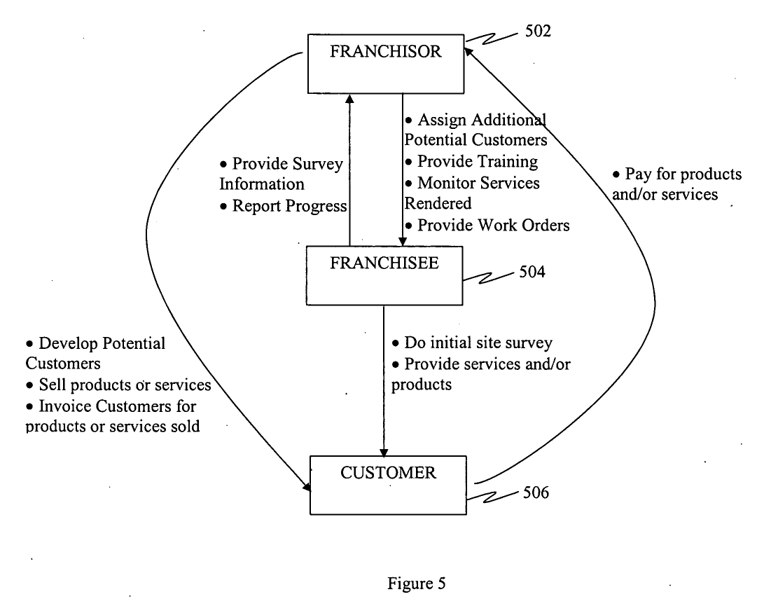

FIG. 5 illustrates a system for operating a customer-centric business model according to one embodiment of the invention. This franchise may be a fire extinguisher service, maintenance, or exchange, franchise. The franchisee 504 may utilize handheld wireless devices to provide the progress reports to the franchisor 502. The franchisee 504 may utilize the handheld wireless devices to conduct potential customer surveys and/or initial visits and transmit information to the franchisor 502 about the customer's 506 business needs. For example, the franchisee 504 may send information about the customer's building, number of units, or fire extinguisher requirements to the franchisor 502. This information may also be sent from the franchisee 504 to the franchisor 502 via a network, by paper and/or faxed. The franchisor 502 tracks the potential and permanent customer 506 needs and due dates for quarterly and annual service. The franchisee 504 may also receive work orders for potential or permanent customers 506 via the handheld wireless devices, networked device (e.g., computer or facsimile).

According to one embodiment of the invention, the franchisee 504 may submit progress reports on potential and permanent customers 506 to the franchisor 502. Sales inquiries received by the franchisee 504 are referred back to the franchisor 502 for handling.

To grow his/her franchise, the franchisee 504 must have surveyed all or a minimum percentage of currently assigned potential customers 506 and must be current (e.g., up to date) with permanent customer deliveries and services before the franchisor 502 assigns additional potential customers to be surveyed. In this way, the franchisor 502 can monitor that a franchisee is adequately servicing a customer. According to one embodiment of the invention, the franchisor 502 regularly (e.g., weekly, semi-monthly, etc.) assigns new potential customers to a franchisee 504 as long as this condition is met. As previously discussed, the new potential customers may be selected from a list of pre-allocated, but unassigned, potential customers (e.g., properties, locations, etc.) that are associated with the franchisee 504.

The franchisor 502 may also provide any necessary training to the franchisee so that the franchisee can operate his/her franchise. Additionally, the franchisor 502 maintains accounting of any income received on behalf of the franchisee and deducts any management or service fees and product costs provided to franchisee.

According to one embodiment of the invention, the franchising operations provide fire extinguisher maintenance, inspection, repair, and/or recharging services and/or sale of fire safety products. In this fire extinguisher services and/or products operation the franchisee uses a mobile device to collect customer survey information, communicate customer information to the franchisor in near real-time, and/or receive work orders from the franchisor.

The franchisor locates and/or identifies potential customers who may need fire extinguisher services and/or products. The franchisor may identify potential customers in a number of ways. For example, in one embodiment of the invention the franchisor may identify owners and/or operators of apartment buildings. The franchisor may utilize databases that identify apartment owners and may contain owner names, physical addresses and size of properties, etc. Once such database that may be employed is the United States Postal Service address database which identifies addresses for properties in the United States. Using the United States Postal Service address database, possibly in conjunction with other databases, a complete and accurate database of apartment, apartment owners, and/or operators may be obtained.

This collection of information is then used to generate a list of potential customers who can be contacted by phone, mail, email or any other means to determine their level of interest in having their property surveyed and/or obtain fire extinguisher maintenance, repair and/or inspection services. In one example, the potential customers may be grouped into a plurality of allocations. Each allocation may be associated with a franchisee upon initiation of the franchisee's operation.

A franchisee is then assigned one or more of the potential customers who have been initially contacted or identified by the franchisor. The franchisee may then be assigned one or more of these potential customers in various different ways. According to one embodiment of the invention, a potential customer is assigned to a franchisee based on the potential customer's geographical proximity to the franchisee's operations center (e.g., business location, home location, etc.). That is, unassigned potential customers who are closest to the franchisee are assigned to the franchisee. In one embodiment of the invention such assignment may consider assigning only those franchisees that are routably closest to the franchisee. A database, such as the United States Postal Service database, may be used to determine which potential customer locations are geographically and/or routably closest to the franchisee. Routing means that travel factors are taken into account when assigning potential customers to a franchisee. For example, even though two potential customers may only be a few miles apart, a river may divide them, making it very inefficient to assign both customers to the same franchisee. Thus, geographical factors and travel time between customers is taken into consideration when assigning potential customers to a franchisee.

According to another embodiment of the invention, the type and/or nature of potential customers allocated and/or assigned to a franchisee is also evaluated so as to balance the types of buildings, number of units, and/or number of properties that a franchisee may service. For instance, rather than providing only high-rise buildings to a franchisee, the balancing scheme contemplates providing some high-rise buildings in addition to smaller apartment complexes. Such balancing serves several purposes, including increasing the franchisee's likelihood of success. That is, selling services to high-rise buildings often takes an extended period of time and often go through a bid process. Meanwhile, smaller apartment buildings tend to be quicker to signup as a customer and provide a more stable customer base. Thus, the nature of the accounts or customers assigned to a franchisee is considered to improve their chances of success.

Another factor that may be employed is considering the number of total units that are assigned to a franchisee. Considering the total number of units assigned to a franchisee prevents a franchisee from being overwhelmed by having too many large-sized apartment buildings, which typically take longer to survey and/or service, or having too many small-sized apartment buildings, which may require more commuting to service.

Another factor that may be considered when allocating and/or assigning potential customers to a franchisee is the relative distance between apartment buildings. This avoids having some franchisees with very long commutes between properties to be serviced while other franchisees have much shorter commutes between properties to be serviced.

According to one feature of the invention, apartment buildings are assigned to a franchisee whether or not the buildings sign up with the franchisee or never sign up with the franchise. This permits the franchisee to continue to try to obtain such buildings as customers without other co-franchisees competing for the same customer. Moreover, by initially allocating potential customers or properties to a particular franchisee, this prevents franchisees from trying to low bid each other for the same customers. Since franchisees are assigned potential customers and permanent customers (i.e., they cannot get customers on their own) this protects a franchisee from direct competition for their customers from other franchisees. An allocation of potential/prospective customers may expire after a definite period of time (e.g., one year) and may be renewed upon fulfilling certain conditions.

According to one embodiment of the invention franchisees may assign buildings to each other. For example, some franchisees may wish to service certain buildings and not others and where two franchisees agree to exchange buildings, this may be done with or without the franchisor's approval.

Specific fire safety regulations are often defined by local or state governments. These regulations often apply to apartment buildings and dictate the number, location, and type of fire extinguisher and other fire safety equipment. A factor that may be considered when assigning potential customers to a franchisee is the variations in municipal codes for fire and safety. Certain cities, municipalities or local governments may have very strict codes while adjacent neighbors may have quite different codes. For instance, certain cities may require licensing of all personnel that services franchises. Thus, the assignment of potential customers may consider whether those customers are located in different regions than the franchisee and/or whether some customers are located in a region that requires substantially different safety or fire codes than others. This prevents franchisees from having to learn and keep up with varying safety codes. The franchisor gathers each one of these safety regulations for the various locations in which it operates franchises and trains each franchisee in the applicable fire safety regulations for the locality in which their franchise operates.

Once a franchisee is assigned a potential customer, the franchisee surveys the potential customers' property (e.g., apartment buildings, hotels, commercial buildings, retail stores, office buildings, etc.). In one embodiment of the invention, the franchisee may merely survey a property to determine its physical characteristics (e.g., number of units, stairways, entrances, gates, etc.) and provide such information to the franchisor in text or graphical form. Such information may also include the number of apartment units, the square footage of each apartment unit, whether there are carports, parking areas, pools, laundry rooms, the types of structures on the property, whether fire extinguishers or other safety equipment should be installed in various locations.

The franchisee may enter such physical characteristics of a surveyed property into a mobile computing or data collection device in graphical form. In one embodiment, the franchisee may be provided with a digital layout of an apartment building being surveyed and then identifies the physical characteristics (e.g., fire extinguisher locations, stairs, gates, etc.) during the survey. The franchisee may also provide a photograph of the property surveyed, generate a map of the property, and/or provide a report to the franchisor of the types of life safety and/or fire safety equipment present on the property and the last time such equipment was serviced. During the survey, the franchisee may also determine whether the apartment building complies with the local fire safety code, and if not, what items or services are needed to bring it into compliance.

Once the survey information is provided to the franchisor by the franchisee those potential customers surveyed become permanent customers assigned to the franchisee whether or not they end up requesting or purchasing services from the franchise. Once assigned as permanent customers, those customers remain assigned to the franchisee and can only be lost or unassigned under certain circumstances. For example, a permanently assigned customer may be unassigned from the franchisee if the franchisee falsified the survey information. The franchisee may also be required to perform periodic surveys of the assigned properties to maintain that property as a permanent customer. The franchisor may provide periodic reports of which permanently assigned customers need to be surveyed in order for the franchisee to retain them as permanent customers. Another way in which a permanently assigned customer may be unassigned from a franchisee is if the franchisee fails to cure defects in the services previously provided to the customer or fails to adequately service the customer. A customer who is unassigned from a first franchisee may be reassigned by the franchisor to a second franchisee.

A franchisee is assigned additional potential customers by the franchisor on a regular basis so long as the franchisee surveys the properties of previously assigned potential customers and the franchisee is up to date or substantially up to date on servicing existing permanent customers. This permits a franchisee to continue to grow without geographical limitations.

Once the franchisee has completed a survey and sent that information to the franchisor the franchisor stores and processes the survey information to determine what products and/or services should be provided to each potential customer. The franchisor indicates to the franchisee what work should be performed, or products sold, to the apartment building surveyed.

Whatever data is collected by the franchisee is sent back to the franchisor for compilation. Such information is then used by either a centralized or distributed sales force or outside sales people acting on behalf of the franchisor to contact the surveyed customers and inform them of any shortcomings. The franchisor then tries to sign up the surveyed customers for inspection, maintenance, repair and/or other fire extinguisher services. If the customer signs up, then the franchisor sends the franchisee who performed the survey a work order specifying all products and services to be performed. The franchisor may also deliver any products to the franchisee that are needed for servicing of that particular customer.

The franchisee then performs the services and installs or exchanges any products that may be necessary at the customer's apartment buildings. The franchisee also provides a report to the franchisor of all work performed, providing information on any change of services performed.

The franchisor bills the customers, collects payment, and provides the franchisee with their share of the payment. The franchisor bills the customer for any products and/or services sold by the franchisee. Upon receiving payment from the customer, the franchisor credits the franchisee's account with all payments received from his/her assigned permanent customers. The franchisor then deducts its own fees from each franchisee for costs, services, royalties or data maintenance. The franchisor also provides a full accounting of all incomes, goods sold and fees deducted from the franchisee.

Having established a business relationship with certain customers, the franchisor may expand the services sold or offered to those customers. For instance the franchisor may sell or provide locksmith services or fire sprinkler maintenance services to those customers. It may assign a franchisee who provides fire extinguisher services to said customers to also provide locksmith services or fire sprinkler services.

According to one embodiment of the invention, the franchisor may also assign master franchisees to provide services to other franchisees. A master franchise is defined by the franchisees assigned to it and the services that it is allowed to provide to those franchisees. For example, a master franchisee may be licensed to provide fire sprinkler maintenance services, locksmith services, and/or other services to one or more franchisees that provide fire extinguisher services. That is, the master franchisee enables an expansion of services provided to a franchisee's customers. In many instances, the master franchisee may provide services that require specialized training, require particular license(s), and/or costly equipment.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications are possible. It should be clear that the methods and systems described herein are applicable and/or adaptable to various types of service and/or product franchises.

Those skilled, in the art will appreciate that various adaptations and modifications of the described preferred embodiments can be configured without departing from the scope and spirit of the invention. Therefore, it is to be understood that, within the scope of the appended claims, the invention may be practiced other than as specifically described herein.

What is claimed is:

1. A method for assigning and managing franchises, comprising:
identifying potential customers;
assigning specified potential customers to a franchisee; and
assigning additional potential customers to the franchisee only after the franchise has performed one or more specified tasks for the assigned specified potential customers.

2. The method of claim 1 further comprising:
allocating a plurality of potential customers to the franchisee, wherein the assigned specified potential customers are assigned from the allocated plurality of potential customers.

3. The method of claim 1 further comprising:
permanently assigning one or more of the specified potential customers to the franchisee once the franchisee has performed work for the one or more specified potential customers.

4. The method of claim 1 further comprising:
performing an initial survey of a potential customer's needs for one or more franchised services or products.

5. The method of claim 4 wherein the initial survey is performed prior to contacting the assigned potential customers.

6. The method of claim 1 wherein the one or more specified tasks include
performing an initial survey of a potential customer's facilities to collect information about the facility prior to contacting the assigned potential customers.

7. The method of claim 1 wherein the one or more specified tasks includes
providing one or more franchised services or products to one or more of the specified potential customers.

8. The method of claim 1 further comprising:
selling products or services to the potential customers for or on behalf of the franchisee.

9. The method of claim 1 further comprising:
selling services to one or more of the specified potential customers; and
transmitting work orders to the franchisee to perform services for one or more of the specified potential customers.

10. The method of claim 1 wherein the sale of services and transmission of work orders are performed by a centralized franchisor.

11. The method of claim 1 further comprising:
selling products to one or more of the specified potential customers; and
sending products to the franchisee to deliver to one or more of the specified potential customers.

12. The method of claim 1 further comprising:
generating invoices for one or more of the specified potential customers on behalf of the franchisee.

13. The method of claim 1 further comprising:
receiving progress reports from the franchisee regarding servicing of one or more of the specified potential customers.

14. The method of claim 1 further comprising:
monitoring the work performed for the potential customers by the franchisee.

15. The method of claim 1 wherein the potential customers are identified by a franchisor before being assigned to the franchisee.

16. The method of claim 1 wherein the potential customers are limited to apartment building owners or operators.

17. The method of claim 1 wherein a franchisor sells the services to property management companies on behalf of the franchisee.

18. The method of claim 1 wherein the potential customers are assigned to the franchisee based on the potential customer's travel time to the franchisee's center of operations.

19. The method of claim 1 wherein the potential customers are assigned to the franchisee based on the franchisee's routing distance to the potential customer.

20. The method of claim 1 wherein the potential customers are assigned to the franchisee based on their geographical proximity to the franchise and routing time from the franchisee.

21. The method of claim 1 further comprising:
balancing the assignment of the potential customers to the franchisee based on the size and nature of the potential customers' real estate properties.

22. The method of claim 1 further comprising:
assigning one or more of the potential customers to the franchisee as permanent customers once the franchisee performs one or more specified tasks for the one or more potential customers.

23. The method of claim 1 further comprising:
reassigning a permanent customer from a first franchisee to a second franchisee if the first franchisee fails to provide timely services to the permanent customer.

24. The method of claim 1 further comprising:
providing training to the franchisee about local regulations for the regions serviced by the franchisee.

25. The method of claim 24 wherein the local regulations include local fire safety regulations.

26. The method of claim 24 wherein the local regulations for the potential customers are a factor when assigning potential customers to the franchisee.

27. A franchising method comprising:
assigning a potential customer to a franchise, wherein the franchise is defined by the customers assigned to it; and
selling products or services to the potential customer through a franchisor on behalf of the franchise.

28. The franchising method of claim 27
monitoring the work performed by the franchise; and
assigning additional potential customers to the franchise only after the franchise has satisfactorily performed specified tasks for the potential customer.

29. The franchising method of claim 28 wherein the specified tasks include performing a survey of the potential customer's facility.

30. The franchising method of claim 28 wherein the facility survey is used by a franchisor to sell services or products to the potential customer.

31. The franchising method of claim 27 wherein the franchisor generates a work order for the franchise based on the services or products sold to the potential customer.

32. The franchising method of claim 27 wherein the franchise delivers the services or products sold to the potential customer.

33. The franchising method of claim 27 wherein the franchisor generates invoices for services or products sold to the potential customer on behalf of the franchise.

34. The franchising method of claim 27 further comprising:
assigning a second potential customer, located in substantially the same geographical region as the potential customer, to a second franchise.

35. The franchising method of claim 27 wherein the potential customer is selected from a plurality of potential customers based on
the franchisee's travel time to the potential customer, and
the routing distance between the franchise and the potential customer,

36. The franchising method of claim 27 further comprising:
balancing the assignment of additional potential customers to the franchise based on the size and nature of the potential customers' real estate properties, the similarity between local fire safety regulations for the region serviced by the franchise; and
providing training to the franchise about local fire safety regulations for the region serviced by the franchise.

37. A method for operating franchises, comprising:
assigning a first potential customer to a first franchise;
assigning a second potential customer to a second franchise; and
monitoring the work performed by the first and second franchises for their assigned potential customers,
wherein the first and second franchises are defined by the customers assigned to them.

38. The method of claim 37 further comprising:
identifying potential customers; and
assigning additional potential customers to the first franchise only after the first franchise has satisfactorily performed specified tasks for the first potential customer.

39. The franchising method of claim 37 further comprising:
performing a survey of the first potential customer's facility;
selling services or products to the to the first potential customer based on the facility survey;
generating a work order for the first franchise based on the services or products sold to the first potential customer;
delivering the sold services or products to the first potential customer; and
generating invoices for the services or products sold to the first potential customer on behalf of the first franchise.
